(19) United States
(12) Patent Application Publication
(10) Pub. No.: US 2012/0089912 A1
(43) Pub. Date: Apr. 12, 2012

(54) PRESTREAMS

(75) Inventors: Michael Hyman, Bellevue, WA (US); William Caspare, Bellevue, WA (US); Paul Grinchenko, White Plains, NY (US)

(73) Assignee: Oggifinogi, Inc., Seattle, WA (US)

(21) Appl. No.: 13/267,781

(22) Filed: Oct. 6, 2011

Related U.S. Application Data
(60) Provisional application No. 61/390,309, filed on Oct. 6, 2010.

(51) Int. Cl. G06F 3/01

(52) U.S. Cl. 715/716

(57) ABSTRACT

There are disclosed apparatus and processes for playing a prestream. A client computer running a browser has loaded a webpage including instructions for playing a designated stream in a media player. To enable the prestream, prestream control code is included in the webpage such that when a stream initiation action takes place the prestream control code is processed and causes the prestream to be played before the media player plays the stream.

### RELATED APPLICATION INFORMATION

This patent claims priority from Provisional Application No. 61/390,309 filed Oct. 6, 2010, entitled Prestreams.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to displays associated with media players that run in general purpose computing devices.

2. Description of the Related Art

Media players are computer software which play media objects. Individual media objects are referred to herein as content items. The term content item is used herein to refer to a single still image, a unit of a series of still images, or a unit of video. Images and video can be interactive, such that a user's interaction with the playback of a content item causing the playback to change according to definitions within the content item. For example, when an interactive video is played in a window, if the user mouses over the video then the window may be enlarged.

A content item is always provided to a media player as a single file. Some media players require a content item to be completely downloaded before play can begin, though most today can begin playing a content item while the content item is being downloaded.

Media players typically include a user interface (UI). A UI of a program or software routine (i.e., not just media players) is software for a combination of screen displays and instructions how the program or software routine should function based upon user inputs.

As used herein, the term media player means a program for playing back multimedia files, and the term media player interface refers to a UI which can display information about media being played and provides a user some measure of control over the playback. Media players typically include a media player interface. Some media player programs can act as an engine which is called by other programs which provide a media player interface. That is, the software which provides the UI does not itself “play” the audio or video, but instead merely interfaces to a background engine of a media player. In some media players, the UI is generated by the media player alone, and in others it is generated by other software under control of the media player, such as another application, an operating system or middleware.

Media player interfaces often display icons known from physical devices such as tape recorders and CD players. Examples of these icons are icons for play, pause and stop. They sometimes also include icons for fast forward and rewind. When the user clicks or otherwise selects these icons, the UI causes the corresponding function to be performed.

Some media players can be called from other applications. For example, websites often have content items available for a user to play. To enable this, the websites have one or more webpages which include code for launching a media player. When a user browses to such a webpage and provides input to play a content item, code in the webpage causes the media player to play the content item.

Some media players can play streams—content items which having a beginning but may or may not have an end. A stream by definition is capable of being played before it is fully loaded. Podcasts and simulcasts are commonly streamed. A stream can be streamed either live or on demand, and most media players that can play streams will play the stream as it is downloaded rather than waiting for downloading to complete. Since a stream by definition has a beginning but might not have an end, if a media player waits for a stream to end before it starts to play, the media player might not ever start to play.

While many media players can play a variety of types of content items, other media players are limited to only one media type, and some are compatible with only a small number of file formats or encoding schemes. Audio players and video players are example of special-purpose media players, and they typically have a media player interface tailored for the specific media type. For example, many broadcast radio stations provide online playback of conventional radio broadcasts by streaming to an audio-only media player which they provide to the user. These radio stations typically have a website from which a user can launch a media player interface and listen to a stream from the radio station.

When the code in a webpage, such as that of a radio station, causes a media player to play a content item, typically the code also causes a media player interface to be provided. In some cases, such as radio station websites, this code causes a new browser window to be opened having a media player interface. In other cases, such as video sharing websites, the code provides the media player interface within the currently browsed webpage.

Many radio stations run advertisements to generate revenue. From a technical standpoint, these and other online advertisements are content items. Two common advertisement types are the preroll and the companion banner. A preroll is a content item that is displayed by the audio player interface when the audio player interface is first launched but before the audio stream starts. A companion banner is a content item, typically without audio, that is displayed in the audio player interface while the stream is played.

Aside from radio stations, many others provide websites from which streaming media may be played, and also sometimes play prerolls and companion banners. For example, websites for viewing TV programs and short videos typically provide video player interfaces which display prerolls and companion banners. Video player interfaces typically have a window divided into panes, one of which is used for playing the video stream. The preroll is typically played in the video display pane of a video player interface.

Delays are typically inherent in launching and loading a media player, playing a preroll, and starting to play a stream. For example, typical audio players take as much as six to ten seconds to load, and larger audio players can take fifteen seconds or more on fast connections. While the media player is loading it typically plays nothing—not even a preroll. As a result of these delays, users may become frustrated or distracted. Many users, as a result of these delays, exit the media player or close or hide the media player window.

In a media player, the UI is provided in a window on the display of the user's computer, smartphone, tablet, etc. Some devices, such as many smartphones, provide a display for only one running application at a time, and as used herein even such single-display configurations will be considered to have a window for each running application. In those environments, switching between applications is the same as switching between application windows.

### DESCRIPTION OF THE DRAWINGS

FIG. 1 is a block diagram of a network environment.

FIG. 2 is a block diagram of a computing device.

FIG. 3 is a flow chart of a method for prestream display.

FIG. 4 is a sample of prestream scripts.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having the same reference designator.

### DETAILED DESCRIPTION

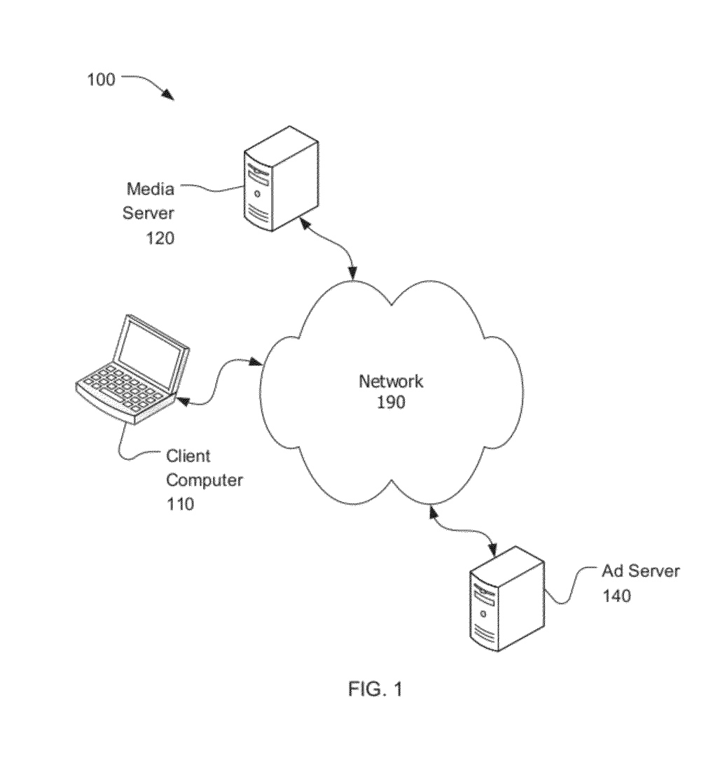

Referring now to FIG. 1, a network environment 100 may include a client computer 110, a media server 120, and an ad server 140 coupled via a network 190. The network 190 may be or include the Internet. Although FIG. 1 shows, for ease of explanation, a single client computer 110 and two servers 120, 140, millions of client computers and servers may be connected to the network 190 simultaneously, and each of these devices 110, 120, 140 is representative.

The client computer 110 may be used by a user to access the network 190. The client computer 110 for practical reasons will usually be a unitary, self-contained device such as a desktop personal computer, a laptop computer, a computing tablet, a set top box, a video game system, or a smartphone. However, the client computer 110 may be any computing device having a user interface system and capable of running a media player.

The media server 120 and the ad server 140 may be distributed systems, having components distributed physically and logically.

The media server 120 stores and specific types of content items and serves them in response to requests received via the network 190 from other devices such as the client computer 110.

The ad server 140 stores content items defining one or more ads. After an ad has been selected, the ad server 140 may provide the content item for the select ad in response to a request from the media server 120 or the client computer 110.

To access content items stored in the media server 120, the ad server 140 and elsewhere on the network 190, the client computer 110 may run a browser such as Microsoft Explorer, Mozilla Firefox, Google Chrome or Apple Safari. A browser as used herein is program which provides a user interface that allows navigation of objects on a client computer, and through navigation the browser retrieves, presents and traverses information resources such as webpages and content items.

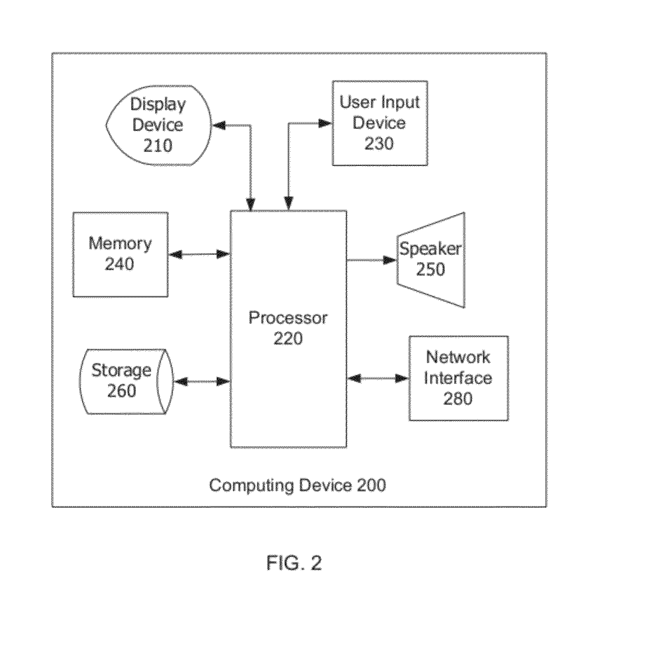

Each of the client computer 110, the media server 120 and the ad server 140 may execute software instructions to perform actions and methods described herein, and each may be a computing device 200 such as that shown in FIG. 2. The computing device 200 may include a processor 220, memory 240, storage 260 and a network interface 280. The computing device 200 may include various specialized units, circuits, firmware, software and interfaces for providing the functionality and features described here. The processes, functionality and features may be embodied in whole or in part in software executed by the processor 220. The hardware, firmware, and software and their functions may be distributed such that some function and features are performed by the processor 220 and others by other devices.

The processor 220 may be a general purpose CPU, and/or a combination of specialized processors.

The computing device 200 may include or be coupled to one or more nontransitory machine readable storage media such as the memory 240 and the storage device 260. The memory 240 and/or the storage 260 may store software instructions for performing the processes described herein. The memory 240 may be static or dynamic solid state memory for temporary storage of programs and data. The storage 260 may be magnetic, optical or solid state memory for longer term storage of programs and data. Both are nontransitory media, and are therefore not a signal or a waveform.

The network interface 280 may be an Ethernet adapter or other communications interface for interfacing the computing device to a network such as the network 190.

In the case of the client computer 110, in order to play content items the computing device 220 includes a user interface system including a display device 210 and a user input device 230. The user interface subsystem may include a speaker 250 to play audio. The media server 120 and the ad server 140 may also have user interface systems.

The display 210 may be a flat panel screen or other display device which can provide images viewable by a user. Instead of a screen another type of display device may be used, such as a projection display or virtual display. The device 210 has a display area having a size in which still images and video may be displayed. In the case of the client computer 110, the display 210 has a display area (not shown) in which windows are displayed, and the client computer 110 can display multiple layers of windows in the display area.

The user input device 230 may be a keyboard and/or pointing device. The computing device may display a pointer on the display 210, and the user input device 230 may be used to move the pointer around the display and select objects displayed objects.

The computing device 200 may run an operating system, including, for example, variations of the Linux, Microsoft Windows, Android, and Apple Mac operating systems.

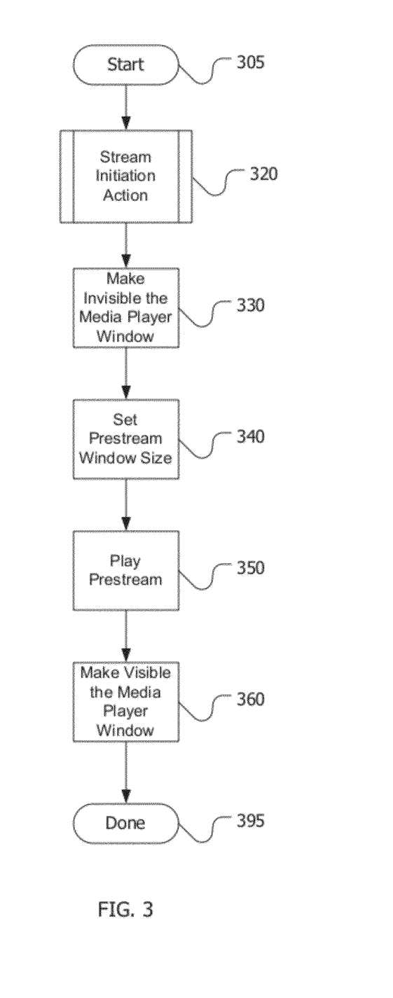

Referring now to FIG. 3 there is shown a flow chart of a process for playing a prestream. As used herein, the term prestream when used as a noun refers to a content item which is played prior to a stream, and when used as a verb refers to the process of playing the content item prior to the stream. The prestream is distinct from the stream. The process operates in a client computer such as the client computer 110. The client computer obtains the stream and the prestream separately, and the prestream is always obtained from outside of the client computer.

The process may be performed on the client computer by a browser in response to a user indicating that a stream should be played by a media player. For example, when a radio station's media player interface is launched from a browser, an interactive video advertisement is prestreamed.

At the start 305 of the process, the client computer may be running a browser which has loaded a webpage including instructions for playing a designated stream in a media player. The webpage and the media player are distinct.

To enable the prestream, one or more script tags may be included in the webpage such that when a stream initiation action takes place the script tags are processed. Some or all of the script tags may be loaded when the webpage is started. A script tag is a type of HTML tag having a script (i.e., a program, usually small) written in a scripting language. A script is interpreted when run, and does not have to be compiled or run as compiled code. Since other forms of instructions may be employed to cause the automatic operations described herein, the following description will refer to prestream control code to refer to these instructions, and script tags are simply one example.

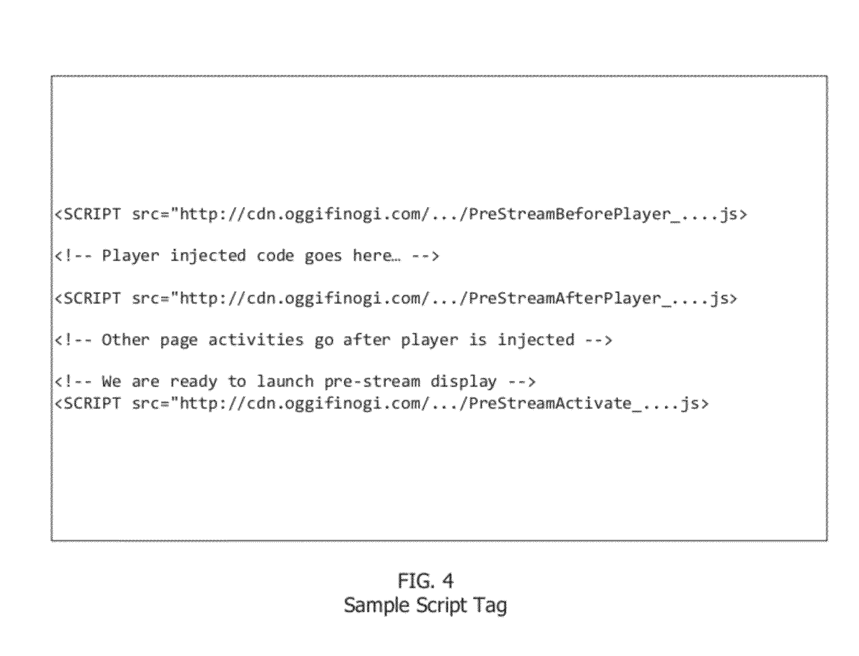

An example of script tags for providing a prestream are shown in FIG. 4. This prestream control code has three parts: a pre-player script tag, an after-player script tag, and a prestream activation script tag. Each of the script portions is responsible for appropriate actions: before player appears on the page, after player injected into the page and when prestream is ready to activate.

At 320 there is a stream initiation action. The stream initiation action is any client computer based act which will normally result in a media player playing a designated stream. The stream may but need not be designated by the user. For example, the stream may be designated automatically. The stream initiation action may be the launch of a media player interface, including a media player window, for playing the designated stream. The stream initiation action may be a user clicking on a link or providing some other input for playing the designated stream. The stream initiation action may be the sending of an instruction to a media player to play the designated stream.

In response to the stream initiation action, the client computer automatically launches a media player interface causing a media player window to be displayed on the display device. The prestream control code may run automatically in response to the stream initiation action. Alternatively, the prestream control code may begin running sooner or at other times as practical, and may directly or indirectly detect the stream initiation action, and/or may detect that the media player window has been launched. The prestream control code may begin automatically when the webpage is opened.

In conjunction with the launch of the media player interface, a server such as the advertising server 140 (FIG. 1) may be called by the webpage to determine if a prestream should be played. The server may also instruct the client computer to play a preroll (i.e., a content item that is displayed by the media player interface when the media player interface if first launched but before the stream starts) and whether the preroll should be given priority over the prestream. Where a preroll is available the media player interface may play the preroll either before or after the prestream, depending on a priority designation. Alternatively, the priority may dictate that only the prestream or only the preroll should be played. It is possible that there are instructions to play a prestream, but no prestream is available. In such a case the prestream process would go to 395 and terminate.

Next, at 330, the prestream control code automatically causes the media player window to be concealed from the user's view. The media player window may be concealed in a number of ways. For example, the prestream control code may cause a request to load the media player to be intercepted, or the prestream control code may instruct the media player not to play automatically. By causing the media player to be called in a paused mode, the media player window may be hidden and/or the media player will not load the stream, and/or the media player will not play the stream. Concealing the media player window may also be accomplished by delaying launch of the media player until after the prestream has played, by delaying launch of the media player for a designated time period, by setting the media player window display attributes to invisible, putting the media player window at a low, concealed or invisible layer, or putting the media player window off screen, or by temporarily setting the width and height to zero, or by covering it with something else. Other techniques may be available depending on the software of the client computer. At this point the prestream control code may also prevent the media player from loading the stream, from continuing to load the stream, or from playing the stream.

The prestream control code may cause a delay in loading the media player, or in starting to play the stream. This delay may be for a predefined period, such as until the prestream has finished playing.

Next, at 340, the prestream control code automatically displays a prestream window in a top layer of the display area so that none of the window is hidden. The prestream window may be a new browser window, and may be configured to appear to peel out of the side and over the webpage from which it was launched, and then, after a period of time, retracts. Alternatively the prestream window may be the same window displaying the webpage from which the media player interface is launched. However, the prestream window is distinct from the media player window, and outside of the context of the media player. The prestream control code specifies a size of the prestream window, for example by automatically computing the size, or from a preset value, or from instructions received from outside of the client computer (e.g., from an ad server). To ensure that the prestream is conspicuous, this size may be large with respect to the size of the display device's display area. The specified size may be full display area of the display device, or may be a substantial portion thereof such as one half or two thirds. If the prestream window is less than the full display area, the prestream window may be made more conspicuous by centering it or some other desirable placement based upon the nature of the display area.

If a preroll is to be played, the preroll may be played at this point in the media player window as usual, or in the prestream window. If the prestream window will play the preroll, the advertising server may be called at this point to determine the preroll to play, and then executes the preroll. Alternatively the preroll may be played in the prestream window after the prestream. If the preroll is played in the prestream window, the prestream window may be automatically sized to that of the media player window.

Next, at 350, the prestream control code automatically plays the prestream in the prestream window. The client computer may obtain the prestream at this point or at an earlier time. The prestream may be obtained by the prestream control code causing an ad server to be called to get the prestream and/or instructions for the prestream. To play the prestream, the prestream control code may inject the code for the prestream into a webpage in the prestream window and invoke it. The prestream or the prestream control code may include code to size the prestream window to the desired size, and such that it cannot be minimized, hidden and/or closed while the prestream is playing. The prestream window may be configured so that there is a user option to stop the prestream from playing after a certain amount of time or from user action.

Next, after a predefined period, at 360 the prestream control code automatically reduces visibility of the prestream window and makes the media player window visible.

The predefined period may be the length of the prestream, or may be some portion, or may be the length of the prestream plus some additional time. When playing the prestream is completed, the prestream may send a message to the prestream window so that the prestream window knows that the predefined period has elapsed. The predefined period may be selected to coincide with known, calculated or estimated delays in launching the media player and starting the designated stream. The predefined period may allow for a pad period as a psychological break between the prestream playing and the media player window being displayed. In this way, as soon as the prestream finishes, the stream (or the preroll, if desired) may begin to play with desired timing.

Reducing visibility of the prestream window may be accomplished by ceasing display of the prestream window, moving the prestream window to a lower layer, hiding the prestream window or shrinking the prestream window. For example, the prestream window may be sized to that of the media player window and placed in a layer below the media player window, and to make the media player window visible and active. Making the media player window visible may include ceasing to prevent the media player from playing the stream.

The prestream control code may include instructions for causing the media player window to be skinned after the prestream has finished. A skin is a customized graphical presentation for computer program display or a website which changes the program's or website's look and feel. Because the skin originates from the prestream control code and not the media player, the skin is not restricted to the capabilities of the media player. Thus, the skin can be larger and more interactive. Also, the skin may be altered over time, so different advertisers can be exposed as the stream continues to play.

The webpage may include other instructions in the prestream control code or another prestream control code for playing other content items while the media player plays. For example, the prestream window may be made visible again or a new window displayed, a content item may be retrieved (e.g., an ad from the ad server), and the content item played in the window. The window may be caused to persist for a period of time. As a further enhancement, there may be a visible or invisible count down timer, and if the user mouses over the content item the window may be expand to a larger format. Otherwise, after the time elapses, the window is closed.

It is also possible to include an entry-point that will allow the media player to execute prestream control code during events within the media player and that are initiated by the media player. This allows a prestream to be played before the stream, but also mid-stream. Embedding prestream control code in this fashion may be employed to launch full page take-over display ads from within a media player that knows nothing about such features. In particular, the prestream control code described above, or separate script tags in a webpage, may be employed in conjunction with a specially designed preroll to force a media player window to play the preroll or some other content item in a predefined size, such as full screen. To accomplish this, several enhancements are provided. First, the prestream control code uses an invisible area of the page, typically a 1×1 pixel area, to inject additional functionality. This is because sites are often set up to inject such 1×1 areas for tracking purposes. This script sets up a communication mechanism that will respond to a predefined handshake. It lies dormant until that handshake is received. This mechanism could involve using an event passing mechanism that operates outside of the webpage, or using a file based semaphore that operates outside of the website. For example, the preroll could write a coded value into a file stored on the local file system, and the hidden script could poll the file system for changes to that file. A system involving specially constructed IDs can be used so that in the case of their being several webpages and several media players open at once, each hidden area only responds to requests from a media player on the corresponding page. The hidden area script is embedded within the webpage and thus has access to all of the capabilities of the browser environment.

By comparison, preroll ads run within media players do not have access to the browser environment. If the preroll unit finds a hidden script that responds to its sent message, it can then send further instructions. For example, the preroll, operating within the constraints of the media player, can then send a message to the hidden script requesting that a much larger, more complex version of the preroll runs. The hidden script will then inject that larger more complex advertising unit into the browser, where it can take over the entire browser experience. When this happens, the preroll unit will simultaneously alter its behavior so that it does not play or so that it is fully paused. When the extended experience completes, it can then hide itself or alter its appearance, and use the same communication mechanism to tell the preroll unit to resume or terminate. This provides a mechanism whereby a very advanced interactive advertising unit can operate in a fashion that is very integrated with a browser experience, yet be launched from a media player that has no knowledge such units and no way to invoke such units. If there is no response from the hidden mechanism, or if the response does not occur in a timely fashion, or if the response is not from an object corresponding to the page containing the player that launched the preroll, then the preroll will operate in its typical, more restricted fashion.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A method of playing a prestream in a computing device in response to a stream initiation action for playing a designated stream in a media player in the computing device, the computing device having a display device with a display area for displaying plural layers of windows, the display area having a size, wherein the stream initiation action causes a media player window to be displayed in the display area for playing the stream, the method comprising, in order:
automatically causing the media player window to be concealed;
automatically displaying a prestream window at a predefined size in a top layer of the display area, wherein the prestream window is distinct from the media player window, and wherein the predefined size is large with respect to the size of the display area;
automatically playing a content item in the prestream window, wherein the content item has been automatically obtained by the computing device from outside of the computing device;
after a predefined period, automatically reducing visibility of the content item and ending concealment of the media player window.

2. The method of claim 1 wherein
causing the media player window to be concealed includes automatically preventing the media player from playing the designated stream; and
ending concealment of the media player window includes ceasing to prevent the media player from playing the designated stream.

3. The method of claim 1 wherein causing the media player window to be concealed comprises causing the media player to be called in a paused mode.

4. The method of claim 1 wherein the predefined size is the display area size.

5. The method of claim 1 further comprising detecting that the media player window has been launched.

6. The method of claim 1 further including delaying calling of the media player until after the predefined period.

7. The method of claim 1 wherein, after the prestream has finished playing, skinning the media player window.

8. The method of claim 1 wherein the content item is at least one of a still image, a video, and an interactive video.

9. The method of claim 1 wherein the content item is obtained automatically by the computing device apart from the stream.

10. The method of claim 1 wherein reducing visibility of the prestream comprises ceasing display of the prestream window, hiding the prestream window or shrinking the prestream window.

11. The method of claim 1 wherein the predefined period comprises a complete playing time of the content item.

12. The method of claim 11 wherein the predefined period further includes a pad period.

13. Apparatus comprising a nontransitory storage medium storing instructions which when executed by a processor in a computing device will cause the processor to play a prestream, in response to a stream initiation action for playing a designated stream in a media player in the computing device, the computing device having a display device with a display area for displaying plural layers of windows, the display area having a size, wherein the stream initiation action causes a media player window to be displayed in the display area for playing the stream, the instructions for:
automatically causing the media player window to be concealed;
automatically displaying a prestream window at a predefined size in a top layer of the display area, wherein the prestream window is distinct from the media player window, and wherein the predefined size is large with respect to the size of the display area;
automatically playing a content item in the prestream window, wherein the content item has been automatically obtained by the computing device from outside of the computing device;
after a predefined period, automatically reducing visibility of the content item and ending concealment of the media player window.

14. The apparatus of claim 13 wherein:
the instructions for causing the media player window to be concealed includes instructions for automatically preventing the media player from playing the designated stream; and
the instructions for ending concealment of the media player window includes instructions for ceasing to prevent the media player from playing the designated stream.

15. The apparatus of claim 13 wherein the instructions for causing the media player window to be concealed comprise causing the media player to be called in a paused mode.

16. The apparatus of claim 13 wherein the predefined size is the display area size.

17. The apparatus of claim 13 further comprising instructions for detecting that the media player window has been launched.

18. The apparatus of claim 13 further including instructions for delaying calling of the media player until after the predefined period.

19. The apparatus of claim 13 further comprising the instructions for, after the prestream has finished playing, skinning the media player window.

20. The apparatus of claim 13 wherein the content item is at least one of a still image, a video, and an interactive video.

21. The apparatus of claim 13 wherein the content item is obtained automatically by the computing device apart from the stream.

22. The apparatus of claim 13 wherein reducing visibility of the prestream comprises ceasing display of the prestream window, hiding the prestream window or shrinking the prestream window.

23. The apparatus of claim 13 wherein the predefined period comprises a complete playing time of the content item.

24. The apparatus of claim 23 wherein the predefined period further includes a pad period.

25. The apparatus of claim 13 further comprising the processor, the display device and the user input device.

26. The apparatus of claim 13 consisting of the storage medium.
